(19) United States
(12) Patent Application Publication
(10) Pub. No.: US 2023/0128950 A1
(43) Pub. Date: Apr. 27, 2023

(54) PHOTOGRAPHY POSITION MANAGEMENT DEVICE AND METHOD, AND COMPUTER-READABLE STORAGE MEDIUM

(71) Applicants: NTT Communications Corporation, Tokyo (JP); 3i, Inc, Seoul (KR)

(72) Inventor: Ken KIM, Seoul (KR)

(73) Assignees: NTT Communications Corporation, Tokyo (JP); 3i, Inc, Seoul (KR)

(21) Appl. No.: 18/145,884

(22) Filed: Dec. 23, 2022

Related U.S. Application Data
(63) Continuation of application No. PCT/JP2021/018536, filed on May 17, 2021.

(30) Foreign Application Priority Data
Jul. 1, 2020 (JP) 2020-114283

(51) Int. Cl. G06T 7/70; H04N 23/60; H04N 23/66

(52) U.S. Cl. CPC G06T 7/70; H04N 23/64; H04N 23/66

(57) ABSTRACT

A technique for enabling accurate management of photography positions is provided. According to the first embodiment, a server device SV generates plan view data in which position coordinates of a photography point are plotted and transmits the plan view data to a user terminal MT, each time a photography operation is performed for a photography point. The plot position of the photography spot in the plan view data is corrected in accordance with a plot position correction request made by a user, and the corrected plan view data is stored as photography position management information.

### CROSS REFERENCE TO RELATED APPLICATIONS

This application is a Continuation Application of PCT Application No. PCT/JP2021/018536, filed May 17, 2021 and based upon and claiming the benefit of priority from Japanese Patent Application No. 2020-114283, filed Jul. 1, 2020, the entire contents of all of which are incorporated herein by reference.

### FIELD

Embodiments described herein relates generally to a photography position management device, method and a non-transitory computer-readable storage medium, which are used, for example, in a system that photographs photography images in a three-dimensional space while moving in the three-dimensional space, and which records the photography images.

### BACKGROUND

In recent years, techniques have been proposed for managing facilities, such as business facilities, offices and residences using images. For example, Patent Literature 1 describes a technique in which a three-dimensional (3D) image showing the inside of a facility is generated by photographing a three-dimensional space of the facility in all directions (360°) at a plurality of different positions, recording the obtained images in a storage medium, and connecting the recorded images. The use of this technique enables a facility manager or a user to remotely grasp the state of the facility by looking at the 3D images without the need to go to the site.

### PATENT LITERATURE

Patent Literature 1: U.S. Patent Application Publication No. 2018/0075652

In the conventionally proposed system, photography positions measured by the photography device are managed in association with photographed images. However, the photography positions measured by the photography device may contain an error depending on the measurement accuracy of the measuring means, so that there is a possibility that the photography positions cannot be managed accurately.

The present embodiment has been made with the above circumstances taken into consideration, and is intended to provide a technique for accurately managing photography positions.

In order to solve the above-described problem, a photography position management device or photography position management method according to the first aspect is used in a system which stores images photographed at a plurality of photography positions while moving in a photography space together with a photographer, which generates photography position management information in which measurement position information at the plurality of photography points is associated with a two-dimensional coordinate system corresponding to the photography space, and which outputs the generated photography position management information and presents it to the photographer. Correction requests made by the photographer for the output photography position management information are acquired, and the photography position management information is corrected based on the acquired correction requests.

According to the first aspect, the generated photography position management information is presented to the photographer, and where the position of the photography point represented by the photography position management information deviates from the actual position, the photography position management information is corrected in accordance with the correction request by the photographer. Therefore, even if the measurement position of the photography point deviates from the actual position owing to the measurement accuracy of a position measurement means, the positional deviation can be corrected by a manual operation of the user.

A photography position management device or photography position management method according to the second aspect is used in a system which stores images photographed at a plurality of photography positions while moving in a photography space together with a photographer, and generates photography position management information in which measurement position information at the plurality of photography points is associated with a two-dimensional coordinate system corresponding to the photography space. The generated photography position management information is collated with a condition representing a photography target range preset for the two-dimensional coordinate system of the photography space to determine whether the measurement position information satisfies the condition. Where it is determined that the measurement position information does not satisfy the condition, the photography position management information is corrected.

According to the second aspect, the generated photography position management information is collated with the condition representing a photography target range preset for the two-dimensional coordinate system of the photography space, to determine whether the measurement position information satisfies the condition. If the measurement position information does not satisfy the condition, the photography position management information is corrected. Therefore, even if the measurement position of the photography point recorded in the photography position management information deviates from the actual position, the positional deviation can be automatically corrected.

The first and second aspects can provide a technique capable of accurately managing photography positions.

### BRIEF DESCRIPTION OF THE DRAWINGS

FIG. 1 is a schematic configuration diagram of a system including a server device that operates as a photography position management device according to first the embodiment.

FIG. 2 is a block diagram showing an example of a hardware configuration of a server device employed in the system shown in FIG. 1.

FIG. 3 is a block diagram showing an example of a software configuration of the server device of the system shown in FIG. 1.

FIG. 4 is a flowchart showing an example of the processing procedures and contents of a photography position management operation executed by the server device shown in FIG. 3.

FIG. 5 is a diagram showing an example of how photography position correction processing is performed in the photography position management operation shown in FIG. 4.

FIG. 6 is a block diagram showing an example of the software configuration of a server device according to a second embodiment.

FIG. 7 is a flowchart showing an example of the processing procedures and contents of a photography position management operation executed by the server device shown in FIG. 6.

### DETAILED DESCRIPTION

Embodiments will now be described with reference to the accompanying drawings.

### First Embodiment

(Configuration Example)

(1) System

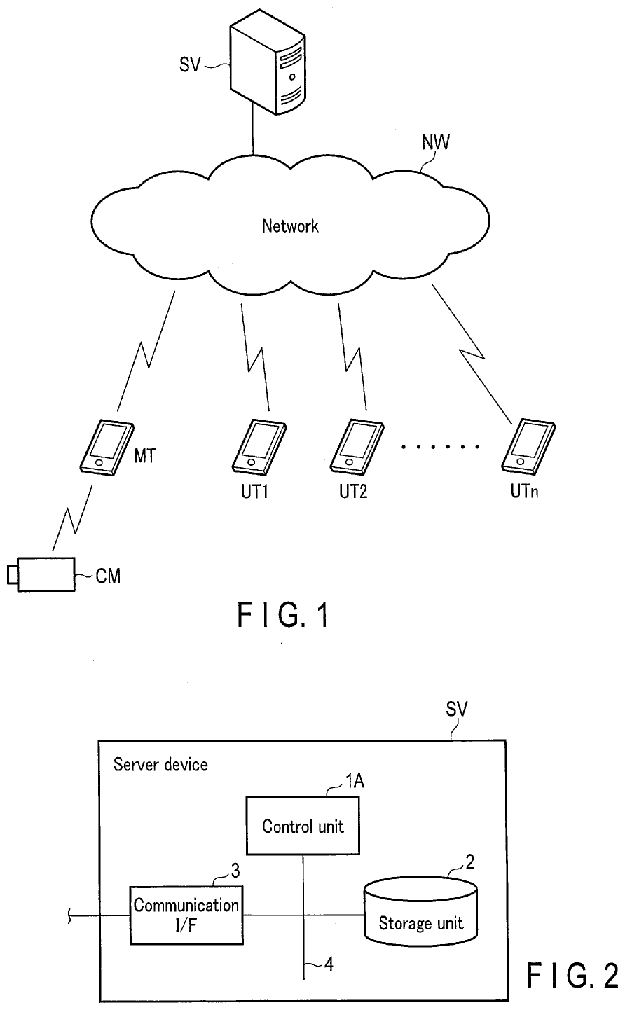

FIG. 1 is a schematic configuration diagram of a system according to the first embodiment.

This system includes a server device SV that operates as a photography position management device. Data communications are enabled between this server device SV and user terminals MT and UT1 to UTn of users via a network NW.

The user terminals MT and UT1 to UTn include a user terminal MT that is used by the user who registers omnidirectional images and user terminals UT1 to UTn that are used by users who browse the registered images. Each of the user terminals is configured as a mobile information terminal, such as a smartphone or a tablet type terminal. It should be noted that a notebook personal computer or a desktop personal computer may be used as a user terminal, and the connection interface to the network NW is not limited to a wireless type but may be a wired type.

The user terminal MT is capable of data transmission to a camera CM, for example, via a signal cable or via a low-power wireless data communication interface such as Bluetooth (registered trademark). The camera CM is a camera capable of photographing an image in all directions, and is fixed, for example, to a tripod capable of maintaining a constant height position. The camera CM transmits photographed omnidirectional image data to the user terminal MT via the low-power wireless data communication interface.

The user terminal MT also has a function of measuring its current position using signals transmitted, for example, from a Global Positioning System (GPS) or a wireless Local Area Network (LAN). The user terminal MT has a function of enabling the user to manually input position coordinates as a reference point in case the position measurement function cannot be used, as in the case where the user terminal MT is in a building.

Each time the user terminal MT receives omnidirectional image data photographed at one position from the camera CM, the user terminal MT calculates position coordinates indicative of the photography position, based on the position coordinates of the reference point and the moving distance and moving direction measured by built-in motion sensors (e.g., an acceleration sensor and a gyro sensor). The received omnidirectional image data is transmitted to the server device SV via the network NW together with information on the calculated photography position coordinates and photographing date and time. These processes are executed by pre-installed dedicated applications.

The user terminals UT1 to UTn have browsers, for example. Each user terminal has a function of accessing the server device SV by means of a browser, downloading an image showing how a desired place of a desired facility and floor is at a desired date and time in response to a user's input operation, and displaying the downloaded image on a display.

The network NW is composed of an IP network including the Internet and an access network for accessing this IP network. For example, a public wired network, a mobile phone network, a wired LAN, a wireless LAN, Cable Television (CATV), etc. are used as the access network.

(2) Server Device SV

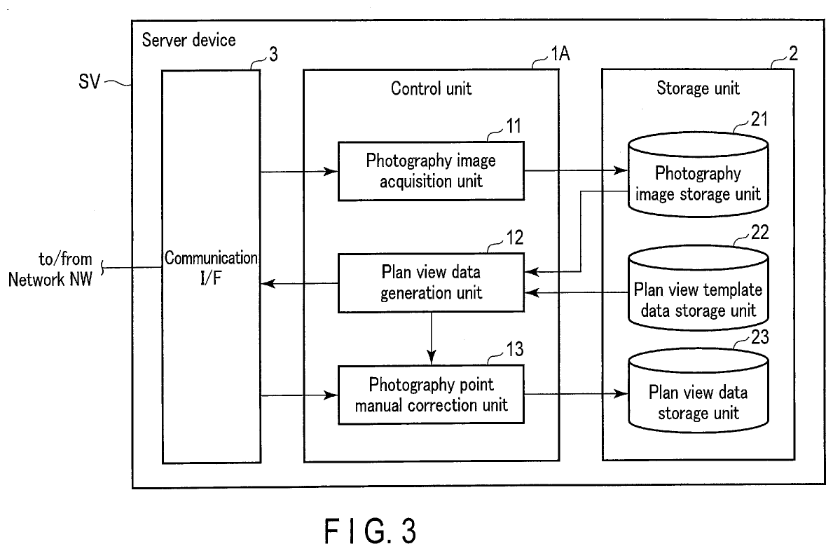

FIGS. 2 and 3 are block diagrams that show the hardware and software configurations of the server device SV, respectively.

The server device SV is composed of a server computer installed on the cloud or the Web, and includes a control unit 1A having such a hardware processor as a central processing unit (CPU). A storage unit 2 and a communication interface (communication I/F) 3 are connected to the control unit 1A via a bus 4.

The communication I/F 3 transmits and receives data to and from the user terminals MT and UT1 to UTn via the network NW under the control of the control unit 1A, and uses a wired network interface, for example.

The storage unit 2 uses, for example, a nonvolatile memory, such as a Hard Disk Drive (HDD) or a Solid State Drive (SSD), which serves as a main storage medium and for which data can be written and read at any time. As the storage medium, a Read Only Memory (ROM) and a Random Access Memory (RAM) may be used in combination.

A program storage area and a data storage area are provided in the storage area of the storage unit 2. Programs necessary for executing various control processes related to the first embodiment are stored in the program storage area, in addition to middleware such as an Operating System (OS).

In the data storage area, a photography image storage unit 21, a plan view template data storage unit 22, and a plan view data storage unit 23 are provided as storage units necessary for carrying out the first embodiment.

The photography image storage unit 21 is used to store all omnidirectional images photographed by the camera CM for each photography point in association with information representing the photographing dates and times and the photography positions.

The plan view template data storage unit 22 stores a plan view template representing the two-dimensional coordinate space of each floor of the facility to be photographed and information representing the photography conditions. The plan view template is a plan view in which a layout representing how rooms, equipment, etc. are arranged for each floor in a two-dimensional coordinate space. The photography conditions define photography target ranges in the two-dimensional coordinate space, and are set in advance for each floor.

The plan view data storage unit 23 is used to store plan view data obtained by plotting the position coordinates of the measured photography points on the plan view template for each floor, and the plan view data is stored as photography position management information.

The control unit 1A includes a photography image acquisition unit 11, a plan view data generation unit 12, and a photography point manual correction unit 13 as control processing functions according to the first embodiment of the present invention. Each of these processing units 11 to 13 is implemented by causing a hardware processor to execute a program stored in the program storage area of the storage unit 2.

Each time the photography image data photographed at each photography point is sent from the user terminal MT, the photography image acquisition unit 11 receives the photographed image data via the communication I/F 3, and stores the received photography image data in the photography image storage unit 21 in association with information representing the photography position coordinates and the photographing date and time which are received together with the image data.

The plan view data generation unit 12 generates plan view data in which the photography position coordinates of a photography point are plotted on a plan view template, each time information representing the photography image, the photography position and the photographing date and time is acquired for each photography point. Then, a process of transmitting the generated plan view data from the communication I/F 3 to the user terminal MT is performed. It should be noted that the plan view data generation unit 12 reads a plan view template from the plan view template data storage unit 22 or reads photography position coordinates of the photography point from the photography image storage unit 21 in the process for generating the plan view data.

If a correction request for the plot position of the photography point is received from the user terminal MT in response to transmission of the plan view data, the photography point manual correction unit 13 corrects the plot position of the corresponding photography point in the plan view data, and the corrected plan view data is stored in the plan view data storage unit 23.

(Operation Example)

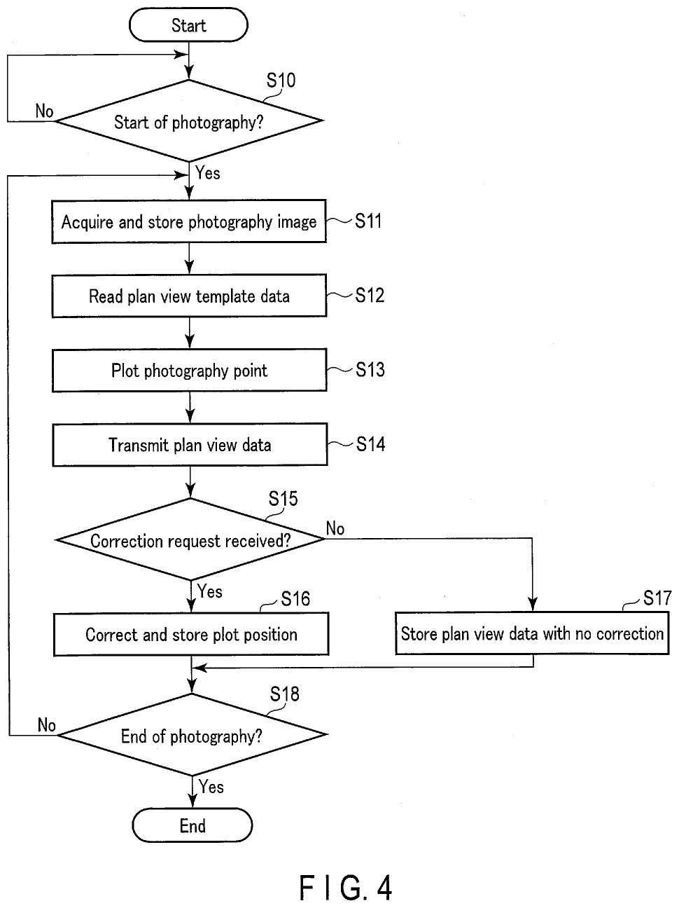

Next, an operation example of the server device SV configured as described above will be described. FIG. 4 is a flowchart showing an example of the processing procedures and processing contents.

(1) Initial Setting Performed Prior to Start of Photography

Where a request to start photography is transmitted from the user terminal MT in order to start photographing a photography target floor, the server device SV performs the processing for acquiring a reference point. That is, the server device SV reads the plan view template data of the floor to be photographed from the plan view template data storage unit 22, and transmits the read plan view template data from the communication I/F 3 to the request-making user terminal MT. This plan view template data is received by the user terminal MT and displayed on the display.

In this state, the user uses the plan view template data of the floor to be photographed and sets a position from which the photography of the floor is to be started as a reference point. Then, the user obtains position coordinates of this reference point from the coordinate system of the plan view template data, and inputs them to the user terminal MT by operating an input unit. The user terminal MT saves the input position coordinates of the reference point and transmits them to the server device SV. The reference point may be set at any position within the photography target floor.

Where the position coordinate data of the reference point is transmitted from the user terminal MT, the server device SV receives the position coordinate data of the reference point via the communication I/F 3, and stores the position coordinate data in the storage area of the control unit 1A.

(2) Photography Operation by User and Acquisition of Photography Image Data

On the floor to be photographed, the user moves the camera CM from the reference point to a photography point and performs a photography operation. The photography image data which the camera CM photographs in all directions is transmitted to the user terminal MT, and is then transmitted from this user terminal MT to the server device SV. At this time, in the user terminal MT, the position coordinates of the photography point are calculated based on the position coordinates of the reference point and a moving distance and a moving direction measured by built-in motion sensors (e.g., an acceleration sensor and a gyro sensor). The calculated position coordinates of the photography point are added to the omnidirectional image data at the photography point together with information representing the photography date and time, and the resultant omnidirectional image data is transmitted to the server device SV.

Thereafter, each time the user moves to a new photography point and performs a photography operation, the user terminal MT calculates position coordinates of the new photography point, for example, based on the position coordinates of the previous photography point. The calculated position coordinates of the photography point are transmitted to the server device SV together with the omnidirectional image data photographed at the new photography point.

Where the server device SV receives a photography start request transmitted from the user terminal MT in step S10, the server device SV acquires photography image data for each photography point under the control of the photography image acquisition unit 11. That is, in step S11, the photography image acquisition unit 11 receives all omnidirectional image data via the communication I/F 3 in step S11, which are transmitted from the user terminal MT for each photography point. The received omnidirectional image data are stored in the photography image storage unit 21 in association with information indicative of the position coordinates of the photography points and photographing dates and times, which are received together with the omnidirectional image data.

(3) Generation of Plan View Data

Where the omnidirectional image data is obtained for each photography point, the server device SV generates plan view data in step S12 under the control of the plan view data generation unit 12. That is, the plan view data generation unit 12 first reads a plan view template corresponding to the floor to be photographed from the plan view template data storage unit 22. Then, in step S13, the photography position coordinates of the photography point transmitted from the user terminal MT are read from the photography image storage unit 21 and plotted on the two-dimensional coordinate space of the read plan view template. Plan view data in which the position coordinates of the photography point are plotted is thus generated.

Subsequently, in step S14, the plan view data generation unit 12 transmits the generated plan view data from the communication I/F 3 to the user terminal MT. At this time, the plan view data generation unit 12 may simultaneously issue a message such as “Check the position of the photography point for which the photography has been performed, and correct the plot position to the accurate position if correction is necessary.”

(4) Correction of Plot Position of Photography Point

By viewing the plan view data displayed on the display of the user terminal MT, the user determines whether the position of the photography point displayed in the plan view data corresponds to the actual position of the photography point on the floor to be photographed. If the position of the photography point displayed in the plan view data has to be corrected, correction data at the photography point display position is input manually.

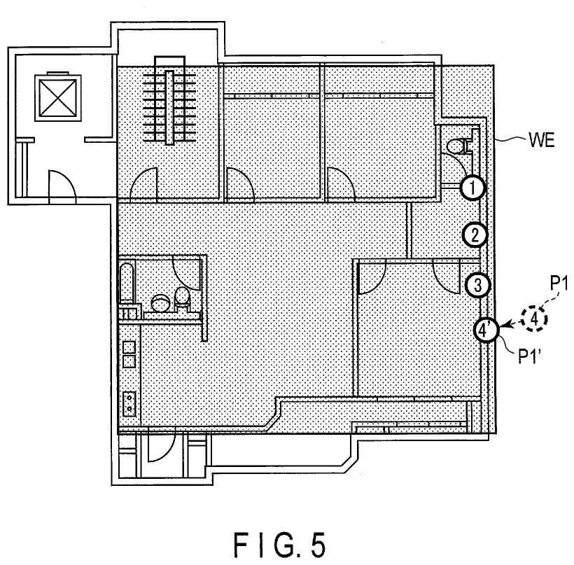

For example, let it be assumed that the plot position of the photography point currently displayed on the plan view data is P1 shown in FIG. 5. In this case, the user operates the mouse to move the plot position P1 to the correct position P1′ on the plan view data. If correction is not required, the user inputs correction-unnecessary data by clicking, for example, a “no correction button” displayed on the plan view data. The user terminal MT includes either the correction data or correction-unnecessary data of the photography point in a correction request, and transmits this correction request to the server device SV.

Where the correction request is transmitted from the user terminal MT, the server device SV first determines in step S15, under the control of the photography point manual correction unit 13, whether the correction request including the correction data is received or if the correction request including the correction-unnecessary data. If the result of this determination shows that the correction request including the correction data is received, the plot position of the photography point in the plan view data previously generated by the plan view data generation unit 12 is corrected in accordance with the correction data in step S16. Then, the corrected plan view data is stored in the plan view data storage unit 23.

On the other hand, where the result of the above determination shows that the correction request including the correction-unnecessary data is received, the plan view data previously generated by the plan view data generation unit 12 is left uncorrected and stored in the plan view data storage unit 23 in step S17.

The above-described process from the acquisition of photography image data to the generation of plan view data, and the manual correction process are repeated for each of the photography points. Where, in step S18, a notification is received from the user terminal MT to the effect that all of the photography operations on the floor to be photographed have been completed, a series of processes are ended.

The server device SV may store new plan view data in the plan view data storage unit 23 for each photography point, but the plan view data stored in the plan view data storage unit 23 may be read and updated for each photography point, and plan view data in which all photography points are finally plotted may be stored in the plan view data storage unit 23.

(Operations and Advantageous Effects)

As described above, according to the first embodiment, the server device SV generates plan view data in which the position coordinates of the photography point are plotted and transmits the plan view data to the user terminal MT, each time the photography operation is performed for a photography point. The plot position of the photography spot in the plan view data is corrected in accordance with the plot position correction request made by the user, and the corrected plan view data is stored as photography position management information.

Therefore, even if the means for measuring the position of a photography point undergoes a measurement error and the plot position of the photography point in the plan view data is shifted thereby, the position coordinates of the photography point in the plan view data can be corrected according to the user's correction operation based on this plan view data.

According to the first embodiment, based on a reference point arbitrarily set by the user, the position coordinates of the photography point are calculated based on the moving distance and moving direction measured by the built-in motion sensor of the user terminal MT, and the server device SV plots the position coordinates on the plan view data. For this reason, errors in position coordinates may be accumulated for each photography point, and there is a concern that the position of the photography point plotted on the plan view data may largely deviate from the actual position of the photography point. In the first embodiment, however, the plot position of each photography point is presented to the user and can be corrected according to the user's operation, as described above. It is therefore possible to reduce the influence of measurement errors which may be caused by the position measurement means.

### Second Embodiment

In the second embodiment according to the present invention, plot positions of photography points in plan view data are automatically plotted in the server device SV based on photography conditions for the photography target floor stored in the plan view template data storage unit 22 in advance. It is intended to be corrected.

(Configuration Example)

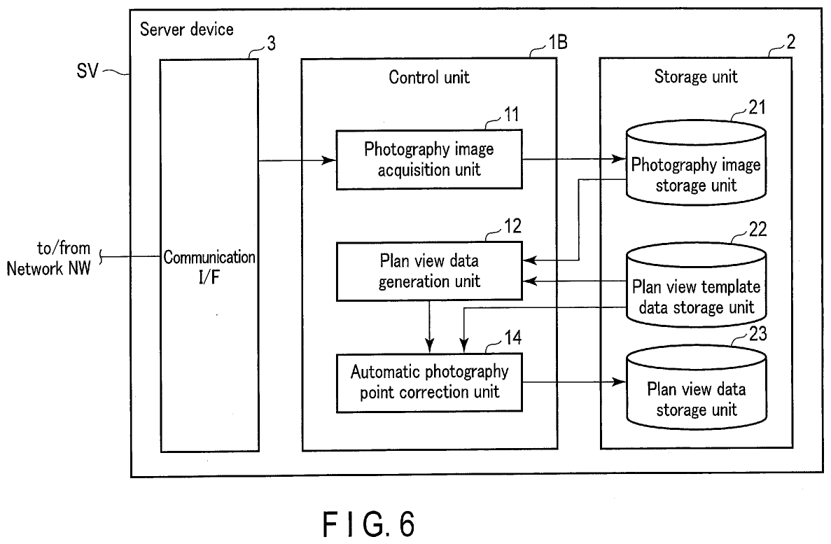

FIG. 6 is a block diagram showing an example of the software configuration of a server device SV that operates as a photography position management device according to the second embodiment. In FIG. 6, like reference numerals denote like parts in FIG. 3, and a detailed description of such parts will be omitted.

In FIG. 6, the control unit 1B of the server device SV includes an automatic photography point correction unit 14, in addition to a photography image acquisition unit 11 and a plan view data generation unit 12. Similarly to the processing by the photography image acquisition unit 11 and the plan view data generation unit 12, the processing by the automatic photography point correction unit 14 is realized by causing the control unit 1B to execute the program stored in the program storage unit.

The automatic photography point correction unit 14 compares the position coordinates of the photography points plotted on the plan view data generated by the plan view data generation unit 12 with the photography target range defined by the photography conditions stored in the plan view template data storage unit 22, to determine whether the plot position coordinates of the photography point are within or outside the photography target range.

Where the determination process determines that the plot position coordinates of the photography point are outside the photography target range, the automatic photography point correction unit 14 calculates a difference value representing how the plot position coordinates of the photography point are away from the photography target range, and performs a process of correcting the plot position coordinates of the photography point in the plan view data, based on the calculated difference value.

(Operation Example)

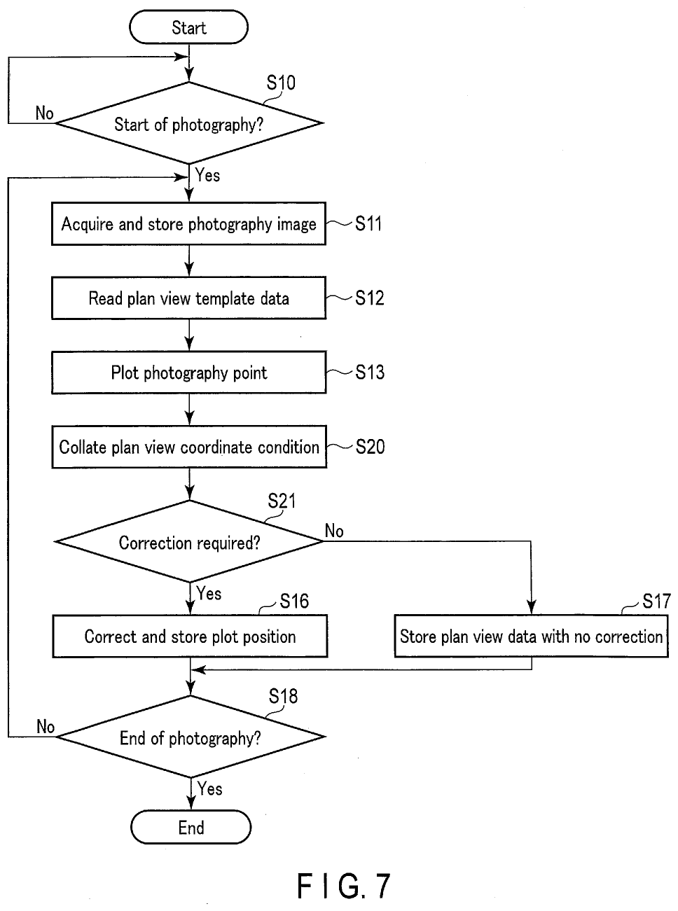

Next, an operation example of the server device SV configured as described above will be described. FIG. 7 is a flowchart showing the processing procedures and processing contents. In FIG. 7 as well, like reference numerals denote like parts in FIG. 4, and a detailed description of such parts will be omitted.

Where photography image data is acquired for each photography point and plan view data is generated by the plan view data generation unit 12, the server device SV corrects the photography points as described below, under the control of the automatic photography point correction unit 14.

That is, the automatic photography point correction unit 14 first reads photography conditions from the plan view template data storage unit 22 in step S20. The photography conditions define a photography target range in the two-dimensional coordinate space of a floor to be photographed. For example, in the example shown in FIG. 5, the photography target range is set as WE. Then, the automatic photography point correction unit 14 compares the position coordinates of the photography points plotted on the plan view data generated by the plan view data generation unit 12 with the photography target range, to determine whether the plot position coordinates of the photography point are within or outside the photography target range in step S21.

If the result of the determination shows that the plot position coordinates of the photography point are outside the photographing target range, the automatic photography point correction unit 14 proceeds to step S16 and calculates a difference value representing how the photography target range is away from the plot position coordinates of the photography target range. As the difference value, for example, the distance and direction of deviation are calculated with respect to the coordinate values. Based on the calculated difference value, the automatic photography point correction unit 14 corrects the plot position coordinates of the photography point in the plan view data such that the difference value becomes zero or lower. The plan view data in which the plot position coordinates are corrected is stored in the plan view data storage unit 23.

On the other hand, if the result of the determination in step S21 shows that the plot position coordinates of the photography point are within the photography target range, the automatic photography point correction unit 14 proceeds to step S17, and stores the plan view data in the plan view data storage unit 23 as photography position management information, without any corrections to the plot position of the photography point.

(Operations and Advantageous Effects)

As described above, according to the second embodiment, the automatic photography point correction unit 14 compares the position coordinates of the photography points plotted on the plan view data with the photography target range defined by the photography conditions, to determine whether the plot position coordinates of the photography point are within or outside the photography target range. Where the plot position coordinates of the photography point are outside the photography target range, a difference value representing how the plot position coordinates of the photography point are away from the photography target range is calculated, and the plot position coordinates of the photography point in the plan view data are corrected, based on the calculated difference value.

Therefore, even if the means for measuring the position of a photography point undergoes a measurement error and the plot position of the photography point in the plan view data is shifted thereby, the positional shift is detected based on the photography target range previously set as a correction condition, and the position coordinates of the photography point in the plan view data can be corrected based on the difference value representing the positional shift. That is, the positional shift of the plot position can be automatically corrected with no need for relying on the user's manual correction operation.

### Other Embodiments

(1) In each of the above-described embodiments, each time a photography operation is performed at a photography point, plan view data in which the photography position coordinates are plotted is generated and transmitted to the user terminal MT, and the plot position is corrected in accordance with the user's correction operation. However, this is not restrictive, and when the photography operation for all the photography points on the floor to be photographed is completed, plan view data in which the position coordinates of all the photography points are plotted may be generated and transmitted to the user terminal MT. Of all photography points, only the photography points for which a correction request is made may be collectively corrected in accordance with the correction operation of the user.

(2) In each of the embodiments described above, the user terminal MT calculates position coordinates of photography points, and the server device SV acquires the calculated position coordinates together with the photographed image data. However, this is not restrictive, and the user terminal MT may measure the moving distance and moving direction of a photography point and transmit the measurement data to the server device SV, and the server device SV may calculate the position coordinates of a photography point, based on the measurement data.

(3) In connection with the above embodiment, reference was made to the example in which the function of the photography position management device is provided for the server device SV, but that function may be provided for an inter-network connection device such as an edge router or for a user terminal MT. Alternatively, the control unit and the storage unit may be provided separately in different server devices or terminal devices, and these devices may be connected via a communication line or network.

(4) The configuration of the photography position management device, the procedures and processing contents of the photography position management process, etc. can be variously modified without departing from the gist.

That is, the embodiments are not limited to what was described above and can be embodied in practice by modifying the structural elements without departing from the gist. In addition, various inventions can be made by properly combining the structural elements disclosed in connection with the above embodiments. For example, some of the structural elements may be deleted from each of the embodiments. Furthermore, structural elements of different embodiments may be combined properly.

### REFERENCE SIGNS LIST

SV: server device
MT, UT1-UTn: user terminal
NW: network
CM: camera
1: control unit
2: storage unit
3: communication I/F
4: bus
11: photography image acquisition unit
12: plan view data generation unit
13: photography point manual correction unit
14: automatic photography point correction unit
21: photography image storage unit
22: plan view template data storage unit
23: plan view data storage unit

What is claimed is:

1. A photography position management device used in a system that stores images photographed at a plurality of photography points while moving in a photography space together with a photographer, comprising:
a management information generation unit configured to generate photography position management information in which measurement position information at the plurality of photography points are associated with a two-dimensional coordinate system corresponding to the photography space, to output the generated photography position management information, and to present the generated photography position management information to the photographer;
a correction request acquisition unit configured to acquire a correction request which the photographer makes for the output photography position management information; and
a correction processing unit configured to correct the photography position management information, based on the acquired correction request.

2. The photography position management device according to claim 1, wherein the management information generation unit is further configured to generate plan view data in which measurement position information on the photography points is plotted on a plan view representing the two-dimensional coordinate system corresponding to the photography space, and to output the generated plan view data.

3. A photography position management device used in a system that stores images photographed at a plurality of photography points while moving in a photography space together with a photographer, comprising:
a management information generation unit configured to generate photography position management information in which measurement position information at the plurality of photography points is associated with a two-dimensional coordinate system corresponding to the photography space;
a determination unit configured to collate the generated photography position management information with a condition representing a photography target range preset in the two-dimensional coordinate system corresponding to the photography space, and to determine whether the measurement position information satisfies the condition; and
a correction processing unit configured to correct the photography position management information where the measurement position information is determined as failing to satisfy the condition.

4. The photography position management device according to claim 3, wherein the correction processing unit is further configured to calculate a difference by which coordinates of the measurement position information differ from coordinates representing the photography target range in the two-dimensional coordinate system, and to correct the coordinates of the measurement position information in the two-dimensional coordinate system, based on the calculated difference.

5. A photography position management method executed by an information processing device used in a system that stores images photographed at a plurality of photography points while moving in a photography space together with a photographer, the method comprising:
generating photography position management information in which measurement position information at the plurality of photography points is associated with a two-dimensional coordinate system corresponding to the photography space, outputting the generated photography position management information, and presenting the generated photography position management information to the photographer;
acquiring a correction request which the photographer makes for the output photography position management information; and
correcting the photography position management information, based on the acquired correction request.

6. A photography position management method executed by an information processing device used in a system that stores images photographed at a plurality of photography points while moving in a photography space together with a photographer, the method comprising:
generating photography position management information in which measurement position information at the plurality of photography points is associated with a two-dimensional coordinate system corresponding to the photography space;
collating the generated photography position management information with a condition representing a photography target range preset in the two-dimensional coordinate system corresponding to the photography space, and determining whether the measurement position information satisfies the condition; and
correcting the photography position management information where the measurement position information is determined as failing to satisfy the condition.

7. A non-transitory computer-readable storage medium storing programs for causing a processor of the photography position management device recited in claim 1 to execute a process of each unit of the photography position management device.

8. A non-transitory computer-readable storage medium storing programs for causing a processor of the photography position management device recited in claim 2 to execute a process of each unit of the photography position management device.

9. A non-transitory computer-readable storage medium storing programs for causing a processor of the photography position management device recited in claim 3 to execute a process of each unit of the photography position management device.

10. A non-transitory computer-readable storage medium storing programs for causing a processor of the photography position management device recited in claim 4 to execute a process of each unit of the photography position management device.
